(19) United States
(12) Patent Application Publication
(10) Pub. No.: US 2010/0092634 A1
(43) Pub. Date: Apr. 15, 2010

(54) METHOD FOR INCREASING THE SHELF LIFE OR AGRICULTURAL PRODUCTS WHICH PRODUCE ETHYLENE, DURING TRANSPORT, SALE, PRESENTATION AND/OR STORAGE

(75) Inventors: Norbert Rodler, ZOLLING (DE); Volker Fleischmann, Empfertshausen (DE)

Correspondence Address: VENABLE LLP, P.O. BOX 34385, WASHINGTON, DC, 20043-9998, US

(73) Assignee: FRAUNHOFER-GESELLSCHAFT ZUR FORDERUNG DER ANGEWANDTEN FORSCHUNG E.V., MUNCHEN (DE)

(21) Appl. No.: 12/302,666

(22) PCT Filed: May 29, 2007
(86) PCT No.: PCT/DE07/00965

§ 371 Date: Apr. 6, 2009

(30) Foreign Application Priority Data
May 30, 2006 (DE) 10 2006 025 491.0
Jul. 26, 2006 (DE) 10 2006 034 602.5

(51) Int. Cl. B65B 55/00; B32B 27/10; A23B 7/00

(52) U.S. Cl. 426/395; 428/34.2

(57) ABSTRACT

The present invention relates to a method for increasing or influencing the shelf life of agricultural products which produce ethylene during transport and/or storage. In the method, the products are transported, sold, presented, and/or stored in packages made of corrugated cardboard (1), which is provided with materials (4) which absorb and/or adsorb ethylene. The method allows an improved shelf life of agricultural products with little expenditure for the user.

### TECHNICAL AREA

The present invention relates to a method for increasing the shelf life of agricultural products which produce ethylene during transport, sale, presentation, and/or storage, as well as corrugated cardboards which are implemented for use in the method.

Ethylene is produced as a gas by agricultural products such as fruit, vegetables, cut flowers, or potted plants, and is simultaneously responsible for the activation of the metabolism and the ripening of these products. For this reason, for example, tropical fruits must be harvested in the countries of origin in the still unripe state, so that they do not ripen too early and arrive spoiled at the end user. However, this has the result that the quality and/or taste of the products may not completely develop. With increasing ripeness, more and more ethylene is produced by plant foods and the ripening is thus accelerated more and more. The growth of microorganisms, changes of nutritional value, taste, smell, color, and consistency, and finally the spoiling of the food are the result.

To avoid and/or counteract these changes, ethylene absorbers (ethylene-sorbing materials, i.e., adsorbers or absorbers) are parceled out in the form of packets or sachets and subsequently laid on the foods, which sorb the produced ethylene. The packets must be removed from the display again in the store, usually by hand, however, because these foreign bodies are not accepted by the consumer. From this moment, the reactions described above may again run unobstructed. Furthermore, the packets containing the ethylene absorbers must also be disposed of separately.

### SUMMARY OF THE INVENTION

The object of the present invention comprises specifying a method for increasing the shelf life of agricultural products which produce ethylene during transport, sale, presentation, and/or storage, which allows an improved shelf life with little effort for the user. Furthermore, suitable means are to be provided for performing the method.

The object is achieved by the method and the corrugated cardboard according to claims 1 and 7. Advantageous embodiments of the method and the corrugated cardboard are the subject matter of the subclaims or may be inferred from the following description.

In the suggested method for increasing or influencing the shelf life of agricultural products which produce ethylene during transport, sale, presentation, and/or storage, the products are transported, sold, presented, and/or stored in packages made of the packaging material “corrugated cardboard”, which is equipped with materials which absorb and/or adsorb ethylene. Corrugated cardboard is also an advantageous packaging material for agricultural products, because in contrast to other packaging materials with comparable effect, it may be easily recycled. Corrugated cardboard has at least one corrugated paper web and/or paper ply, which is glued to smooth paper webs—the cover webs and/or cover plies. This fixing holds the corrugation in shape and also provides the light paper with an especially high stability against mechanical effects. In addition to the single-sided corrugated cardboard, i.e., one ply of corrugated paper which is glued to a cover ply, and the single-corrugation corrugated cardboard having one ply of corrugated paper between two cover plies, multi-corrugation corrugated cardboard is also known, which comprises two or more plies of corrugated paper, which are glued to one another in each case by an intermediate ply of paper or paperboard and whose free external faces are each also glued to one ply each of paper or paperboard as cover plies.

In the present method, these corrugated cardboards, which may be both single-sided, single-ply, and also multi-ply, are provided with materials which absorb and/or adsorb ethylene. Materials of this type are commercially available. These may be, for example, activated carbon, zeolites, potassium permanganate, kaolin, titanium dioxide, clay, calcium carbonate, tetrazine, or bromide. Of course, this is not an exhaustive list.

The materials which absorb or adsorb ethylene are not visible to the end user in the present method, so that the products may also remain in the possibly opened package in the display in the store. In particular, the user does not have to perform additional handling, in particular add additional parts to the products or remove them therefrom.

A special advantage of the present method is that the materials which absorb or adsorb ethylene may already be integrated in the corrugated cardboard during its production. Additional work steps are thus dispensed with, because the incorporation may be integrated in the production process. In addition, the disposal is dispensed with, because the absorbers or adsorbers may be removed from the fraction during recycling without additional expenditure. Due to the better distribution of the materials over the entire package, the effect (sorption of ethylene in the packaging headspace) is significantly increased. The products such as fruit or vegetables may thus be harvested, stored, and presented later and thus in higher quality and the shelf life and freshness of the products lengthen significantly.

The materials which absorb or adsorb ethylene are especially advantageously not applied to the external surface of the corrugated cardboard, i.e., the external cover ply, for this purpose, as is performed in one embodiment of the present method, but rather integrated and/or incorporated in the corrugated cardboard or the paper material of the corrugated cardboard.

The materials may thus already be incorporated in the paper and/or the paperboard during the production of this paper or paperboard for the corrugated cardboard. This may relate to both the cover papers and also the corrugated paper, which are subsequently joined to form the corrugated cardboard. For this purpose, the corresponding material is preferably introduced into a liquid paper precursor during the paper production. A paper precursor of this type results during the production of paper, in which fibrous materials initially float in water and glue and possibly fillers and/or colorants are added thereto, before the paper web is compressed therefrom and subsequently dried. The materials which absorb or adsorb ethylene may be added to this mixture with the glue and possible fillers in this case.

In a further, especially advantageous embodiment of the present method, the materials which absorb or adsorb ethylene are incorporated during the production and/or generation of the corrugated cardboard.

In a possible variant of this embodiment, the corrugation valleys of the corrugated paper ply, or also multiple corrugated paper plies, are doped with the appropriate material and subsequently glued to the cover paper to form corrugated cardboard. The adhesion of the materials which absorb or adsorb ethylene is ensured via suitable binders, as also in other embodiments. The introduction of the materials into the corrugation valleys may be performed, for example, in that the corrugated paper ply is provided with a binder before the application of the upper cover ply, which is subsequently removed again from the corrugation peaks, for example, using a scraper. The surface of the corrugated paper ply prepared in this way is subsequently doped with the ethylene absorber, so that it is bound in the corrugation valleys because of the binder. The cover ply is subsequently glued in a known way onto the corrugated paper ply.

In another variant of this embodiment, the materials are mixed with glue, which is used for the bonding and/or stiffening of different plies of the corrugated cardboard. This may be the starch glue or a cold glue, for example, which is used for pasting together the cover papers with the corrugated paper.

In all embodiments cited up to this point, the corrugated cardboard does not carry an external coating having the materials, so that it also may not be destroyed by mechanical action.

However, total or partial reconditioning of the external surface of the corrugated cardboard may also be performed in the present method to achieve an improvement of the shelf life of the transported or stored products. The materials may be applied to one of the cover plies using paint, lacquer, or silicone, for example.

The application of the materials which absorb or adsorb ethylene may thus be performed in various production stages of the corrugated cardboard. Of course, a combination of the present embodiments and variants is also possible, in which, for example, one part of the materials is introduced into the glue for gluing the corrugated cardboard and another part is introduced into the corrugation valleys of the corrugated cardboard.

The present method and the associated corrugated cardboard having the correspondingly integrated or applied materials which absorb or adsorb ethylene may be used for various applications. The area of application extends over all agricultural products which may be harvested. The corresponding packages may be used, for example, for direct marketing, as the transport package, for temporary storage, or also as the final package in trade.

### BRIEF DESCRIPTION OF THE DRAWINGS

The present method and the corrugated cardboard used therefor are explained once again briefly hereafter on the basis of exemplary embodiments in connection with the drawings, without restriction of the protective scope predefined by the patent claims. In the figures:

FIG. 1 shows a first example of an embodiment of the corrugated cardboard used in the method;

FIG. 2 shows a second example of an embodiment of the corrugated cardboard used for the method;

FIG. 3 shows a third example of an embodiment of the corrugated cardboard used for the method; and

FIG. 4 shows a schematic illustration to visualize a cover paper of a corrugated cardboard used in the method having integrated ethylene absorber.

### DETAILED DESCRIPTION OF THE EMBODIMENTS

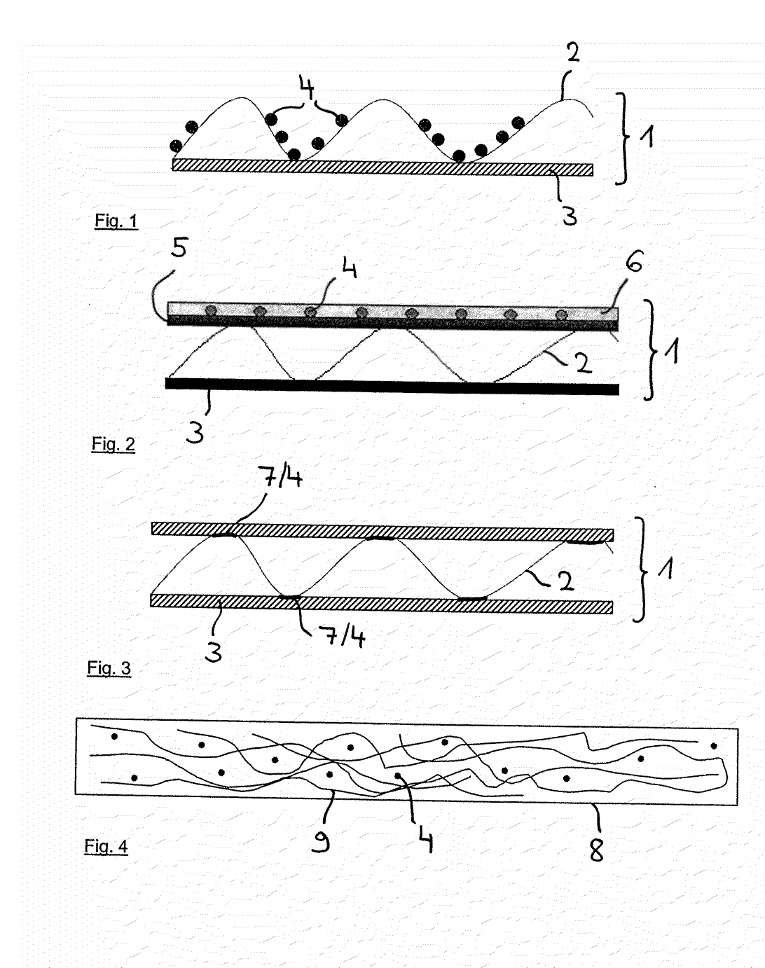

In the present method, the agricultural products are introduced into a package made of corrugated cardboard, in which they are transported, sold, presented, and/or stored. FIG. 1 shows an example of a corrugated cardboard 1 used for this purpose in a schematic illustration in detail. The corrugated cardboard 1 shown in FIG. 1 is a single-sided and single-corrugation corrugated cardboard, in which the corrugation 2 is fixed on only one side on a paper or cover ply 3. This paper ply simultaneously represents the external cover of the corrugated cardboard. An ethylene absorber 4, which is schematically symbolized in this and following figures by the circles, was already applied in the corrugation valleys on the inside of the corrugated cardboard during the production of the corrugated cardboard. The binder previously introduced into the corrugation valleys to increase the adhesion of the ethylene absorber 4 is not shown in this figure.

FIG. 2 shows a further example of the embodiment of a corrugated cardboard in the present method, again in a schematic detail illustration. The figure shows a single-corrugation corrugated cardboard 1, in which the corrugation 2 is fixed between two cover plies 5, 3 in this case. The lower cover ply 3 represents the external cover, and the upper cover ply 5 represents the internal cover of the corrugated cardboard in the package. In the present embodiment, a lacquer 6 having integrated ethylene absorber is applied as a coating to the internal cover. The ethylene absorber may thus also sorb the ethylene produced by the products in the package here. Instead of the lacquer 6, this coating may also be a printing ink having integrated ethylene absorber 4.

In a further embodiment of the corrugated cardboard used in the method, the ethylene absorber is mixed with the starch glue 7 of the corrugated cardboard, which is used to fix the corrugation 2 on the cover plies 3, 5, as is shown as an example in FIG. 3.

In a further exemplary embodiment, one or more plies of the corrugated cardboard, for example, one or both cover plies and/or the corrugated paper, preferably the internal cover paper (internal cover), may already have integrated ethylene absorber. The integration of this ethylene absorber may be performed during the paper production, as was already explained in the preceding description. FIG. 4 illustrates, in very schematic form, a cover paper 8 of this type, which may be used as the cover ply 5 of the corrugated cardboard 1. The paper fibers 9 of the cover paper and the ethylene absorber 4 intercalated between them are indicated very schematically in the figure. In this case, the ethylene absorbers may also directly sorb the ethylene produced by the products in the package, without appearing to the handlers or consumers.

### LIST OF REFERENCE NUMERALS

1 corrugated cardboard
2 corrugation
3 cover ply
4 ethylene absorber
5 cover ply
6 lacquer
7 starch glue
8 cover paper
9 paper fibers

1-13. (canceled)

14. A method for increasing the shelf life of agricultural products that produce ethylene during transport, sale, presentation, and/or storage, comprising:
providing corrugated cardboard packaging comprised of materials which absorb and/or adsorb ethylene; and
packaging the products in the corrugated cardboard packaging.

15. The method according to claim 14, wherein the providing step includes mixing at least a part of the materials with glue that is used for bonding and/or stiffening different plies of the corrugated cardboard.

16. The method according to claim 14, wherein the providing step includes introducing at least a part of the materials into corrugation valleys of at least one corrugated paper ply of the corrugated cardboard.

17. The method according to claim 14, wherein the providing step includes using corrugated cardboard packaging in which at least a part of the materials is already introduced into a liquid paper precursor during paper production for paper plies of the corrugated cardboard.

18. The method according to claim 14, wherein the providing step includes applying at least a part of the materials as a coating to an external surface of the corrugated cardboard.

19. A combination comprising corrugated cardboard and materials which absorb and/or adsorb ethylene contained in or applied to the corrugated cardboard.

20. The combination of claim 19, wherein at least a part of the materials is contained in glue, which bonds and/or stiffens different plies of the corrugated cardboard.

21. The combination according to claim 19, wherein the corrugated cardboard includes two external cover plies and at least a part of the materials is between the two external cover plies.

22. The combination according to claim 19, wherein the corrugated cardboard includes at least one corrugated paper ply having corrugation valleys, and at least a part of the materials is contained in the corrugation valleys of the at least one corrugated paper ply.

23. The combination according to claim 19, wherein the corrugated cardboard comprises one or more plies made of paper containing at least a part of the materials.

24. The combination according to claim 19, wherein the corrugated cardboard has an external surface coated with at least one part of the materials.
